(19) United States
(12) Patent Application Publication
(10) Pub. No.: US 2005/0039929 A1
(43) Pub. Date: Feb. 24, 2005

(54) Horseshoe

(76) Inventors: Karl-Erik Johansson, Berteliusvagen (SE); Erling Persson, Akerhusvagen (SE)

Correspondence Address: YOUNG & THOMPSON, 745 SOUTH 23RD STREET, 2ND FLOOR, ARLINGTON, VA, 22202, US

(21) Appl. No.: 10/493,599

(22) PCT Filed: Oct. 24, 2002
(86) PCT No.: PCT/SE02/01937

(30) Foreign Application Priority Data
Oct. 26, 2001 (SE) 0103566-6

(51) Int. Cl. A01L 1/02

(52) U.S. Cl. 168/23

(57) ABSTRACT

A horse-shoe made of synthetic material, preferably polyurethane plastic (PUR), having a bottom ground face (2), an upper hoof face (3), and a number of nail holes (7) for passing of horse-shoe nails. The horse-shoe has a sectional profile comprising two or more up-right members running side by side in the arcuate length of the horse-shoe, the members connecting said ground and hoof faces. At least one of said members (10) in a vertical plane having a vertical dimension substantially greater than a horizontal dimension of the member such that a length (1) of the member is at least 1.5 times a width (w) thereof in said vertical plane, and stiffening walls (12) arranged in the hoof face (3) between the up-right members of the sectional profile.

### TECHNICAL FIELD

This invention relates to horse-shoes made of synthetic materials in accordance with the preamble of claim 1. Specifically, the invention relates to a synthetic material horse-shoe wherein measures are taken in order to provide a shoe for the horse's hoof that is adapted to the natural movements in the hoof.

### BACKGROUND AND PRIOR ART

Conventionally, by hoof is meant the horn capsule and organs surrounded by the capsule, comprising the wall, sole, and frog. The wall comprises a front toe portion, intermediate side wall portions, quarters and buttresses. In the buttress portions, the wall is cornered to extend forwardly from the buttresses on each side of the frog in the hoof's sole. The flexibility in the hoof, or the hoof mechanism, is thus made possible by the wall not being a closed circle. Underneath the frog the hoof has an organ consisting of fibrous and elastic fatty tissue having indefatigable elasticity. This organ, the elastic pad, is of major importance for the flexibility in the hoof and its capacity to absorb shock. The hoof also contains considerable volumes of blood, and the hoof mechanism is active for circulating the blood in the hoof, and the lower extremity as well. Among the more important objects of the hoof is the capacity to carry weight, to absorb shock, to activate blood- and lymph circulation, and to provide anti-slip.

The shock absorbing capacity of the hoof is primarily provided from the aft portions of the hoof, i.e. the frog, buttresses and the elastic pad, since in a normal step the horse lands on the buttresses. Shock and weight is absorbed in the frog and the elastic pad, which are flattened and expanded laterally causing the aft portions of the hoof to widen as quarters and buttresses are flexed sideways. When the hoof is not loaded, the hoof returns to original shape due to the elastic structure of its tissues.

Below, the mobility of the hoof in the above mentioned aspects will be referred to as the hoof's flexion, relating primarily to the flexing movements of the quarters and buttresses in a horizontal plane. A horse-shoe that obstructs a free flexion of the hoof and, e.g., prevents the frog from contact with the ground, may cause different injuries to the hoof and the extremity.

Conventional horse-shoes are typically made of metal or light metal. Metal shoes are lacking of flexibility in the aspects discussed above. In order not to obstruct the hoof flexion, these shoes are usually nailed in the toe and side portions of the horn wall, while the quarters/buttresses portions are left without nails in order to allow these portions to flex relative to the quarter's arms of the shoe. The relative motion however causes a wear to the quarters of the horn wall that leads to an incomplete contact between the hoof and the shoe, and sometimes causes an exaggerated load on the nails.

Shoes of plastic or other synthetic materials are previously known in many different shapes. Low weight, less risk for injuries caused by the shoed hoof striking a leg, and simple manufacture are some of the advantages provided from plastic shoes. Many of the plastic shoes that are available are however connected with drawbacks, such as instability, and inability to distribute the load uniformly over the hoof. Also, the plastic shoes often do not supply the necessary resistance to abrasion, and accordingly the plastic shoes are not widely used. Plastic horse-shoes typically has a homogenous section, without specific measures for controlling or directing the loads acting on the shoe. This is supposed to accelerate exhaustion of the material in a shoe that is designed without directional elasticity. Prior attempts to stabilize the plastic horse-shoe include, e.g., the arrangement of transverse members connecting the quarter arms of the shoe, resulting however in the obstruction of a flexibility that would support the mobility of the hoof.

A problem faced when designing a horse-shoe made of plastic or other synthetic material is thus to secure the necessary stability and resistance to abrasion in a shoe that also supports the flexion of the hoof in a horizontal plane. Another problem connected with the production of plastic or synthetic horse-shoes is to secure form stability in a molded member.

The present invention aims to avoid these and other problems by providing a horse-shoe made of plastic or other synthetic material, defined by the characterizing features of claim 1. Advantageous embodiments of the horse-shoe will be further defined in the subordinated claims.

Briefly, a synthetic material horse-shoe, preferably made of polyurethane plastic (PUR) is suggested, having a bottom tread face (ground face) and an upper load face (hoof face) for the hoof, and a number of holes for passing of horse-shoe nails. The shoe has a sectional profile comprising upright members connecting said tread and load faces, the members running alongside in the arcuate length of the horse-shoe. In a vertical plane, at least one of said upright members has a vertical dimension substantially greater than a horizontal dimension of same member, such that a length of the member is at least 1.5 times the width of the member in said vertical plane. In a preferred embodiment, the upright members in the sectional profile of the shoe has essentially a uniform width for the whole length of the shoe, running in parallel side by side in the arcuate length of the horse-shoe.

### DRAWINGS

The invention is more fully described below with reference to the accompanying drawings, wherein

FIG. 1 is a diagrammatic section showing the invention implemented in a basic embodiment of a horse-shoe;

FIG. 2 shows the load face of a shoe having the preferred sectional profile shown in FIG. 4d;

FIG. 3 shows the tread face of the shoe in FIG. 2;

FIG. 4a-4d show alternative embodiments of the horse-shoe according to the invention, in sectioned views corresponding to FIG. 1, FIG. 4d showing the section along the line IV-IV of FIG. 3, and

FIG. 5 shows a detail of a nail hole broken away from the shoe.

### DETAILED DESCRIPTION OF THE INVENTION

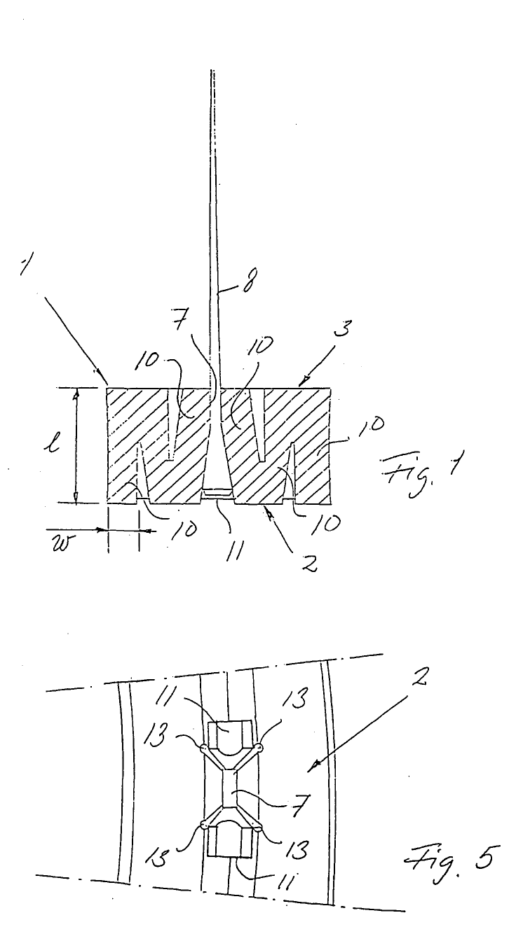

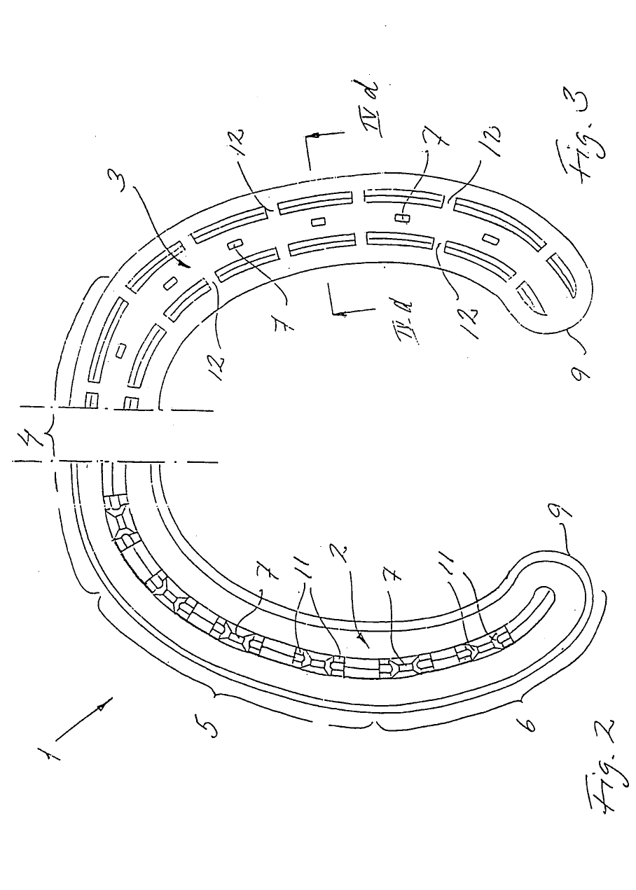

A horse-shoe 1 according to the invention is explained with reference to FIGS. 1-3. The horse-shoe 1 is made of synthetic material, such as polyurethane plastic (PUR) having a durometer of at least 90 degrees Shore A, or above. The material may be reinforced such as from carbon fibers, glass, etc., included to a few or some ten or twenty percents. For example, the reinforcement may be uniformly distributed in the material or concentrated to the bottom tread face, from now on referred to as the ground face of the shoe as commonly accepted name.

Preferably, the horse-shoe 1 is produced through molding, typically comprising a bottom ground face 2 and an upper hoof face 3 extended in an arcuate shape the length of the shoe, from a toe 4, via side portions 5 to the terminal ends of the two quarter portions 6 in the aft end of the shoe. A number of nail holes 7, for passing the nails 8, are essentially uniformly distributed in the length of the shoe, from the toe, through the side portions and preferably comparatively far towards the terminal ends 9 of the quarter portions. Conventionally, the axial directions of the nail holes are adapted to the sloping angle of the hoof wall for adequate guidance of the nails as the shoe is attached to the hoof. In the shown embodiments, the nail holes 7 are passing through from ground face to hoof face. Advantageously, the nail holes may also be formed as blind holes covered by a thin material layer in the hoof face, thus preventing earth or mud from passing through nail holes that are not used for attachment of the shoe. It will be understood that the exact number of nail holes may differ from the number shown in the drawings, offering an option for nailing the shoe to the hoof. In this connection it will also be mentioned that the spacing of the holes may be varied along the length of the shoe, such that the holes in the toe portion, e.g., are more closely spaced.

The horse-shoe 1 is designed to have a sectional profile that is determined in respect of controlling the inherent elastic properties of the material into a flexibility, that is mainly directed in the horizontal plane. Avoiding the typical homogenous section of a conventional horse-shoe, the inventive horse-shoe has a sectional profile comprising one or more upright members, connecting the ground and hoof faces and running side by side in the arcuate length of the shoe. In a vertical plane, at least one such upright member 10 has a vertical dimension that is essentially greater than a horizontal dimension of the same member, such that the length 1 of the member is at least 1.5 times the average width w of the member, in said vertical plane.

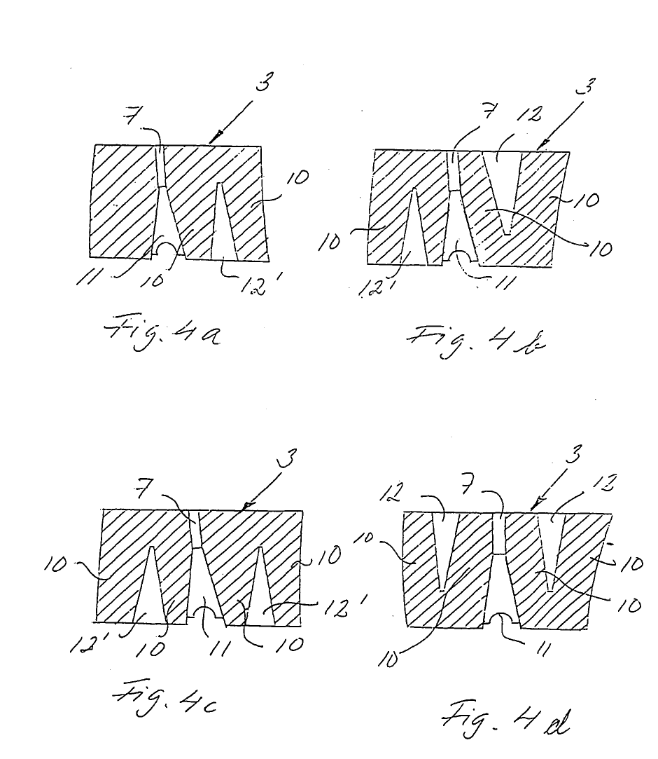

In a preferred embodiment, the invention suggests that at least one of the members 10, forming the sectional profile, is slanting relative to a vertical line to join with an adjacent member 10 in the hoof face and/or the ground face, forming thereby a lattice structured section as illustrated in FIG. 1. Such a lattice section foresees that the upright members 10 are at least two, included in an A-section substantially as in the embodiment shown in FIG. 4a. Alternatively, the upright members are at least three and included in an N-section according to the embodiment of FIG. 4b. Most preferred, the upright members 10 are at least four and included in an M-section or a W-section as illustrated in the sectional views of FIGS. 4c and 4d, respectively. Furthermore it is preferred that two adjacent upright members in the sectional profile are slanting in the vertical plane and spaced by a distance both adapted for supporting, through a clamping action, two opposite sides of the pyramid shaped and concave neck portion of a nail that is inserted through the horse-shoe.

In order to enhance the torsion rigidity of the horse-shoe, the invention foresees that the upright members of the sectional profile are mutually connected by means of transverse stiffening walls 11, arranged in pairs on each side of the nail holes. The stiffening walls 11 may originate from the ground face, run along the sides of the upright members to a point where these meet below the hoof face. Preferably though, the stiffening walls 11 originate from a level somewhat above the ground face adapted to the end plane of the nail head in the inserted position of the nail, the stiffening walls thereby indicating the adequate insertion depth of the nail as illustrated in FIG. 1. Advantageously, the stiffening walls 11 have slanting side faces and arranged on each side of the nail holes 7 and spaced at a distance adapted for supporting, through a clamping action, the other two opposite sides of the pyramid shaped and concave neck portion of a nail that is inserted through the horse-shoe. The bottom edge of the stiffening wall 11 may be formed with a recess, e.g. a cup shaped recess or a radius, in order to facilitate extraction of the nail by means of a nail puller.

In a similar way, stiffening walls 12 may be transversely arranged to connect the upright members from the hoof face to a point where the upright members meet above the ground face. Corresponding walls 12′ may also be arranged in the bottom side of the shoe, i.e. in the ground face, as illustrated in FIGS. 4a-4c.

Additionally, the stiffening walls 11 may connect to the upright members of the sectional profile through a flute formation 13 in order thereby to avoid formation of cracks when the nail is inserted, such as diagrammatically illustrated on larger scale in FIG. 5.

Stiffening walls 11 and 12 (and 12′ if appropriate) are integrally formed in the horse-shoe 1 and extended essentially in radial directions. Alternatively, or in combination therewith, stiffening walls may also be arranged to extend in mutually crossing directions, angularly to the radius, in the shape of a latticed pattern in the ground face and/or hoof face of the shoe (not shown in drawings). Grips, spikes, toe-caps, supporting caps etc., may likewise be formed integrally with the horse-shoe, or alternatively formed as embedded or separately mounted details. Accordingly, the hoof face may include a friction enhancing pattern such as by rifling, and friction enhancing patterns can correspondingly be formed in the ground face of the shoe.

Providing a sectional profile to a horse-shoe as teached by the invention will enhance the torsion rigidity in a vertical plane, as compared to the elasticity in a horizontal plane. The horizontal elasticity of the shoe allows the shoe to be nailed further aft along the quarter's arms, without obstructing the flexion of the hoof quarters, a flexion that normally may be in the range of about +/−3-5 mm. By varying the slope angle of the innermost upright member, and/or by successively increasing or decreasing the width w of that member, the width ratio between ground and hoof faces may be adjusted to provide a concave horse-shoe with a slanting inner side, if desired. By adequate choice of material, preferably from the group of polyurethane plastics, resistance to abrasion and shock absorption capacity may be adapted to specific ground conditions. By avoiding a homogenous section, industrial production of a molded shoe is facilitated such as through injection molding, while minimizing shrinkage. Alternative embodiments may comprise varying the width of the upright members in longitudinal direction, such that the members running side by side provide a wave shaped pattern in the ground and/or hoof faces. Alternatively, the run direction of the upright members may alternate in the longitudinal direction, the members running side by side thereby providing a zig-zag pattern in the ground and/or hoof faces. Preferably, each upright member has an essentially un-changed section in the whole length thereof, running alongside an adjacent member in the arcuate length of the horse-shoe as in the illustrated embodiments. Above mentioned and described advantages and alternative embodiments of the shoe are made possible in a solution as defined by the accompanying claims.

1. A horse-shoe made of synthetic material having a bottom ground face (2), an upper hoof face (3), and a number of nail holes (7) for passing of horse-shoe nails, characterized by a sectional profile comprising two or more upright members running side by side in the arcuate length of the horse-shoe, the members connecting said ground and hoof faces, at least one of said members (10) in a vertical plane having a vertical dimension substantially greater than a horizontal dimension of the member such that a length (1) of the member is at least 1.5 times a width (w) thereof in said vertical plane, and stiffening walls (12) arranged in the hoof face (3) between the upright members of the sectional profile.

2. The horse-shoe of claim 1, characterized by the upright members having uniform width in the length of the horse-shoe, running in parallel in the arcuate length of the horse-shoe.

3. The horse-shoe of claim 1, characterized in that at least one of the upright members, forming the sectional profile, is slanting from a vertical line to join an adjacent member in the hoof face and/or the ground face thereby forming a lattice structured section.

4. The horse-shoe of claim 3, characterized in that the upright members are at least three and comprised in an N-section.

5. The horse-shoe of claim 3, characterized in that the upright members are at least four and comprised in an M-section or a W-section.

6. The horse-shoe of any previous claim 1, characterized in that the nails holes (7) are formed between two adjacent upright members, said members are slanting in the vertical plane and spaced by a distance both adapted for supporting, through a clamping action, two opposite sides of the pyramid shaped and concave neck portion of a nail (8) that is inserted through the nail hole.

7. The horse-shoe of claim 6, characterized in that said adjacent upright members of the sectional profile are mutually connected in the ground face (2) by means of transverse stiffening walls (11) arranged in pairs, said walls having slanting side faces and spaced at a distance adapted for supporting, through a clamping action, the other two opposite sides of the pyramid shaped and lightly concave neck portion of a nail that is inserted through the nail hole.

8. The horse-shoe of claim 7, characterized in that the stiffening wall (11) in a lower edge has a recess through which the nail is accessed by means of a tool.

9. The horse-shoe of claim 8, characterized in that the transverse stiffening walls (11) connect to adjacent upright members by means of a flute (13) for avoiding the formation of cracks upon insertion of a nail.

10. The horse-shoe according to claim 1, characterized in that spikes are integrally formed in the ground face.

11. The horse-shoe of claim 1, characterized by being produced from polyurethane plastic (PUR) through molding, preferably through injection molding.

12. The horse-shoe according to claim 1, characterized in that the width of the upright members is varied in the longitudinal direction, such that the members running side by side provide a wave shaped pattern in the ground and/or hoof faces.

13. The horse-shoe according to claim 1, characterized in that the run direction of the upright members alternates in the longitudinal direction, the members running side by side thereby providing a zig-zag pattern in the ground and/or hoof faces.
